(19) United States
(12) Patent Application Publication
(10) Pub. No.: US 2026/0274023 A1
(43) Pub. Date: Sep. 17, 2026

(54) CHASSIS COMPONENT

(71) Applicant: ZF Friedrichshafen AG, Friedrichshafen (DE)

(72) Inventors: Dirk Lamla, Bramsche (DE); Christian Maassmann, Merzen (DE); Matthias Behre, Holdorf (DE); Frank Nachbar, Osnabrück (DE); Jonas Richter, Emstek (DE)

(73) Assignee: ZF Friedrichshafen AG, Friedrichshafen (DE)

(21) Appl. No.: 18/872,143

(22) PCT Filed: May 5, 2023
(86) PCT No.: PCT/EP2023/061907

§ 371 Date: Dec. 5, 2024

(30) Foreign Application Priority Data
Jun. 7, 2022 (DE) 10 2022 205 763.5

(51) Int. Cl. B60G 7/00; F16C 11/06

(52) U.S. Cl. CPC B60G 7/005; F16C 11/0657; F16C 11/0695; B60G 2204/416; B60G 2206/013; B60G 2206/11; B60G 2206/7104; B60G 2206/81012; B60G 2206/821; F16C 2208/02; F16C 2220/04; F16C 2226/40; F16C 2326/05

(57) ABSTRACT

A chassis component has at least one articulated housing that defines a blind hole-like recess and includes a connecting element. An end section of the connecting element engages in the recess. The end section of the connecting element has external engagement contours, and the recess has internal engagement contours, where the external engagement contours and the internal engagement contours have corresponding shapes in order to produce a form-fit connection between the articulated housing and the connecting element. In order for the chassis component to be able to withstand higher load requirements, a reinforcement part is arranged inside the articulated housing, where the reinforcement part has a holding section connected to the end section of the connecting element.

### RELATED APPLICATIONS

This application claims the benefit under 35 U.S.C. § 371 as a U.S. National Phase Application of application no. PCT/EP2023/061907, filed on 5 May 2023, which claims the benefit of German Patent Application no. 10 2022 205 763.5 filed on 7 Jun. 2022, the contents of which are hereby incorporated herein by reference in their entireties.

### FIELD OF THE DISCLOSURE

The invention relates to a chassis component comprising at least one articulated housing, wherein said articulated housing has a blind hole-like recess, and comprises a connecting element, wherein an end section of the connecting element engages in the recess and the end section of the connecting element has external engagement contours and the recess has internal engagement contours, wherein the external engagement contours and the internal engagement contours have corresponding shapes in order to produce a form-fit connection between the articulated housing and the connecting element.

### BACKGROUND

A chassis component of this type is known from DE 10 2010 041 791 A1. In this process, the articulated housing is formed by casting or injection molding a plastic material around the end section of the connecting element.

At higher loads, there is a risk that the chassis component will no longer meet the requirements. The articulated housing could buckle, twist undesirably strongly, or break.

### SUMMARY

The underlying task of the invention is to further develop a chassis component of the type mentioned at the beginning in such a way that the chassis component can withstand higher load requirements. In particular, an alternative embodiment is to be provided.

The problem underlying the invention is solved by means of a chassis component as disclosed herein. Preferred embodiments of the invention will be apparent in light of the claims and in the following description.

The chassis component has at least one articulated housing. In particular, the chassis component is designed as a torque rod. The chassis component preferably has two articulated housings. The two articulated housings can be arranged at two opposite ends of the chassis component. Thus, various components of a vehicle's chassis can be or are connected to each other in an articulated manner by means of the chassis component. In particular, the two articulated housings are arranged and/or designed to be mirror-symmetrical to one another.

The articulated housing has a blind hole-like recess. In particular, the recess is designed as a blind hole. Furthermore, the chassis component has a connecting element. The connecting element preferably connects a first articulated housing to a second articulated housing. The connecting element has at least one end section, wherein the end section of the connecting element engages in the recess. In particular, the connecting element has two end sections facing away from each other. In this case, one of the end sections can engage in a recess of an articulated housing. Preferably, the recess of the articulated housing is completely filled by means of the end section of the connecting element.

The end section of the connecting element has external engagement contours, and the recess has internal engagement contours. The external and internal engagement contours are designed to have corresponding shapes in order to achieve a form-fit connection between the articulated housing and the connecting element. Preferably, the external engagement contours of the connecting element and the internal engagement contours of the recess are in a form-fit connection with each other. The internal engagement contours of the recess can be designed and/or designated as mating engagement contours for form-fitting interaction with the external engagement contours of the connecting element. In particular, the internal engagement contours and external engagement contours are designed as corresponding projections and/or recesses. Preferably, the engagement contours are realized as grooves, notches, or ridges. In particular, the articulated housing is secured against being pulled off the end section and/or against twisting around a longitudinal axis of the connecting element by means of the form-fit connection between the articulated housing and the connecting element. Preferably, the connecting element is secured against the receptacle and/or the articulated housing by means of the form-fit connection, with both a form-fit axial lock and a form-fit anti-rotation lock.

According to the invention, a reinforcement part is arranged inside the articulated housing, wherein the reinforcement part has a holding section, and the holding section is connected to the end section of the connecting element.

The advantage of this arrangement is that the chassis component and/or the articulated housing can withstand higher load requirements due to the reinforcement part. In particular, the reinforcement part is designed as a separate component. Preferably, the articulated housing and the reinforcement part form a hybrid component made of at least two different materials. In particular, the material of the reinforcement part is stiffer and/or more resistant to bending and/or breaking than the material of the articulated housing.

In particular, the reinforcement part is at least partially or completely embedded in the material of the articulated housing. The articulated housing may be made of a plastic material. Preferably, the articulated housing is made of a fiber-reinforced plastic material. The reinforcement part can thus be completely enclosed by the material of the articulated housing. This protects the reinforcement part from external environmental influences.

According to further training, the articulated housing has a recess designed as an articulated receptacle. The articulated receptacle or recess can be spherically shaped. The reinforcement part encompasses and/or encircles the articulated receptacle. In other words, the articulated receptacle can be surrounded and/or enclosed by the reinforcement part. In particular, the articulated receptacle is designed to receive an articulated ball in a manner that allows it to move. Alternatively, the articulated receptacle can receive and/or hold a ball cup for the articulated ball. The articulated ball may be formed as part of a ball pivot. Preferably, the articulated housing is injection molded around the articulated ball and/or the ball cup and the end section of the connecting element at the same time in order to manufacture the chassis component.

In another embodiment, a first leg of the reinforcement part extends from a first side of the end section of the connecting element in the direction of the articulated receptacle. Furthermore, a second leg of the reinforcement part extends from a second side of the end section of the connecting element in the direction of the articulated receptacle. In this case, the first page and the second page of the end section face away from each other. In other words, the end section of the connecting element is located between the ends of the first leg and the second leg. The reinforcement part has a ring section, wherein the ring section connects the first leg and the second leg. The ring section extends around the articulated receptacle. In particular, the reinforcement part forms a kind of loop by means of the ring section, which is guided around the articulated receptacle. Preferably, the ring section is designed as an open ring section, wherein there is a gap in the region between the two legs and the gap is filled with the material of the articulated housing and/or the end section of the connecting element.

According to further training. the reinforcement part has at least one opening. In particular, the reinforcement part has several openings. In this case, the at least one or several openings are filled with the material of the articulated housing. By means of the at least one opening or the several openings, a form-fit connection between the reinforcement part and the material of the articulated housing is improved. Preferably, a plurality of openings is arranged in a row, wherein the row of openings is formed in the first leg, in the ring section, and in the second leg. The reinforcement part can have several rows, in particular two rows, each with several openings. The multiple rows can be formed parallel to each other. In particular, the openings of adjacent rows are arranged and/or formed in a staggered manner with several openings offset from one another.

In a further embodiment, the holding section of the reinforcement part is connected to the end section of the connecting element by means of a connecting part or by means of a connecting section of the articulated housing. In this case, the connecting part can be designed as a separate component. In particular, the connecting section of the articulated housing is designed as a single-piece component of the articulated housing itself. The articulated housing may be made of a plastic material. In this case, the connecting section can be formed at the same time as the articulated housing by means of an injection molding method. Preferably, the connecting section of the articulated housing is formed between the holding section of the reinforcement part and the end section of the connecting element. In this case, the connecting section of the articulated housing can, on the one hand, engage in a form-fitting manner in the external engagement contours of the end section of the connecting element and, on the other hand, interact in a form-fitting manner with the holding section.

According to the training, the holding section of the reinforcement part is firmly connected to the end section of the connecting element, in particular by means of an adhesive bond and/or by means of a bonding agent.

In another embodiment, the holding section of the reinforcement part engages in a form-fitting manner in an engagement contour of the external engagement contours of the end section of the connecting element. Thus, in this exemplary embodiment, the holding section of the reinforcement part interacts directly with the end section of the connecting element. In particular, the reinforcement part is secured against being pulled out of the connecting element by the form-fit connection between the holding section and the end section.

According to one training program, the reinforcement part for training the holding section has a first holding tab and a second holding tab. The holding tabs can essentially be L-shaped. The first holding tab engages on a first side of the end section in an engagement contour of the external engagement contours of the end section of the connecting element. The second holding tab engages on a second side of the end section, facing away from the first side, in one of the engagement contours of the external engagement contours of the end section of the connecting element. In particular, one free end of each of the two holding tabs engages in the engagement contour of the external engagement contours of the end section. The free ends of the two holding tabs can face each other. In other words, the end section of the connecting element is arranged between the two holding tabs and/or between the free ends of the two holding tabs. In this case, the reinforcement part is held directly on the end section. In particular, the free ends of the two holding tabs are designed to have corresponding shapes of the engagement contour of the external engagement contours of the end section.

The connecting element may have a longitudinal axis, wherein the connecting element may extend in the direction of the longitudinal axis out of the recess and away from the recess. In particular, the connecting element is designed as a rod or a tube. The connecting element can be made of metal or of plastic, preferably reinforced plastic. For example, the chassis component is designed as a pendulum support, wherein an articulated housing is located at each of two opposite ends of the connecting element.

### BRIEF DESCRIPTION OF THE DRAWINGS

The invention is explained in more detail below, with reference to the figures. In this case, the same reference signs refer to the same, similar, or functionally identical components or elements. The following are shown:

FIG. 1: a partially transparent top view of a first chassis component according to the invention,

FIG. 2: a perspective side view of a reinforcement part on a connecting element for forming the first chassis component according to FIG. 1, and

FIG. 3: a partially transparent top view of a further chassis component according to the invention.

### DETAILED DESCRIPTION

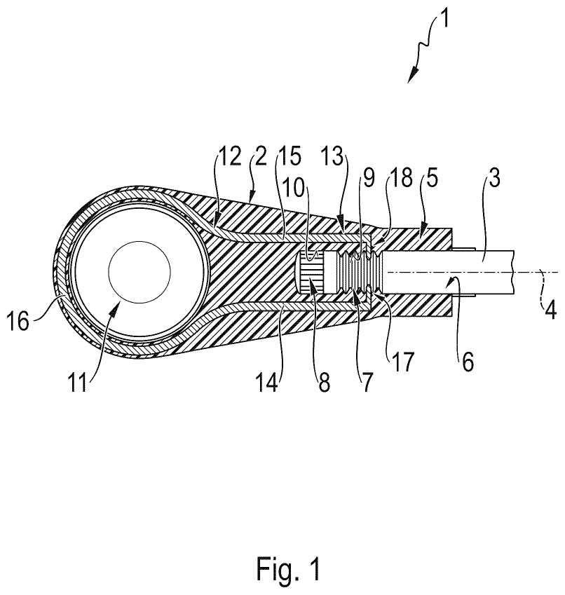

FIG. 1 shows a partially transparent top view of a first chassis component 1 according to the invention. In this exemplary embodiment, the chassis component 1 is designed as a pendulum support, wherein only a first end of the chassis component 1 can be seen here. The chassis component 1 has an articulated housing 2. The articulated housing 2 is made of a plastic material. Furthermore, the chassis component 1 has a connecting element 3. In this exemplary embodiment, the connecting element 3 is designed as a rod and has a longitudinal axis 4. Here, the connecting element 3 is made of metal as an example.

The connecting element 3 has an end section 5, wherein the end section 5 engages in a blind hole-like recess 6 in the articulated housing 2. The end section 5 of the connecting element 3 has external engagement contours 7, 8. In this exemplary embodiment, the external first engagement contours 7 are designed as annular projections or recesses, while the external second engagement contours 8 in this exemplary embodiment are realized as projections or recesses extending in the longitudinal direction of the longitudinal axis 4. The recess 6 has internal engagement contours 9, 10 that are designed to have corresponding shapes to the external engagement contours 7, 8. This forms a form-fit connection between the articulated housing 2 or the recess 6 and the connecting element 3 or the end section 5. This form-fit connection secures the articulated housing 2 both against axial displacement in the longitudinal direction of the longitudinal axis 4 and against twisting around the longitudinal axis 4.

Furthermore, the articulated housing 2 has an articulated receptacle 11 designed as a recess. In this exemplary embodiment, the articulated receptacle 11 is formed in a region of the articulated housing 2 facing away from the recess 6. In addition, the articulated receptacle 11 is realized as a spherical depression. The articulated receptacle 11 is used to receive an articulated ball of a ball pivot, which is not shown in detail here. The recess-shaped articulated receptacle 11 extends transversely or at right angles to the longitudinal axis 4 into the articulated housing 2.

Furthermore, the chassis component 1 has a reinforcement part 12. The reinforcement part 12 is arranged inside the articulated housing 2. The reinforcement part 12 has a holding section 13, wherein the holding section 13 is connected to the end section 5 of the connecting element 3. The reinforcement part 12 is completely embedded in the material of the articulated housing 2. Thus, the reinforcement part 12 is enclosed by the material of the articulated housing 2.

According to this exemplary embodiment, the reinforcement part has a first leg 14 and a second leg 15. The two legs 14, 15 are aligned parallel to each other. Furthermore, the first leg 14 extends from a first side of the end section 5 of the connecting element 3 in the direction of the articulated receptacle 11. The second leg 15 also extends from a second side of the end section 5 of the connecting element 3 in the direction of the articulated receptacle 11. In this case, the two sides of the end section face away from each other. Thus, the end section 5 lies between the two legs 14, 15.

In addition, the reinforcement part 12 in this exemplary embodiment has a ring section 16. The ring section 16 connects the two legs 14, 15. The ring section 16 here extends around the articulated receptacle 11. In other words, the ring section 16 rotates around or encircles the articulated receptacle 11.

In this exemplary embodiment, the reinforcement part 12 has a first holding tab 17 and a second holding tab 18 for forming the holding section 13. The two holding tabs 17, 18 are essentially L-shaped. The free ends of the two holding tabs 17, 18 face each other. The first holding tab 17 engages on a first side of the end section 5 in one of the external engagement contours 7 of the end section 5. The second holding tab 18 engages on a second side of the end section 5, facing away from the first side, in the external engagement contour 7 of the end section 5. Thus, the end section 5 is arranged between the two holding tabs 17, 18, wherein the two holding tabs 17, 18 interact in a form-fitting manner with one of the external engagement contours 7. This results in a predetermined relative positioning of the reinforcement part 12 in relation to the connecting element 3.

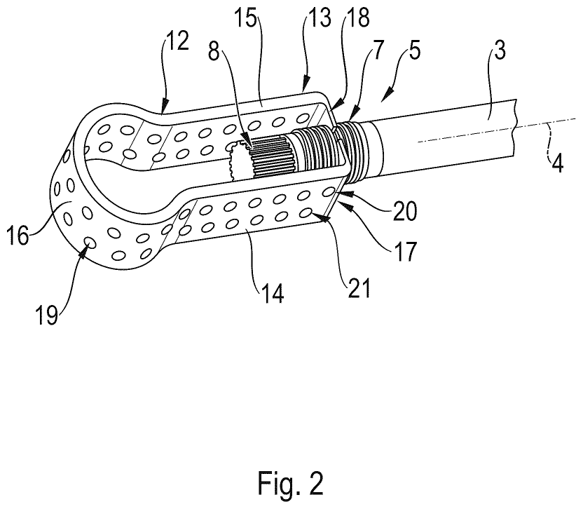

FIG. 2 shows a perspective side view of the reinforcement part 12 on the connecting element 3 for forming the first chassis component 1 according to FIG. 1. In this exemplary embodiment, the reinforcement part 12 has several openings 19. For the sake of clarity, not all openings 19 are provided with a reference number. Here the openings 19 are realized as holes. In the case of the chassis component I according to FIG. 1, the openings 19 are completely filled with the material of the articulated housing 2. This improves the form-fit connection between the material of the articulated housing 2 and the reinforcement part 12.

Here, for example, the multiple openings 19 are arranged or aligned in a first row 20 and in a second row 21. The two rows 20, 21 of openings 19 extend over the first leg 14, the ring section 16, and the second leg 15. Furthermore, in this exemplary embodiment, the openings 19 of the first row 20 are offset and formed relative to the openings 19 of the second row 21.

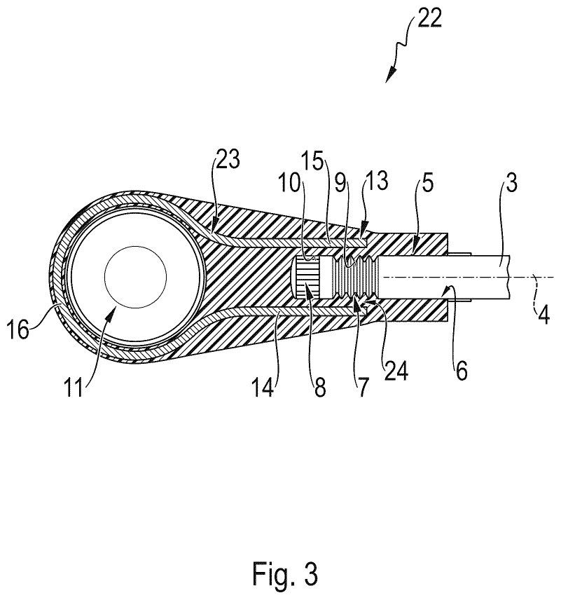

FIG. 3 shows a partially transparent top view of a further chassis component 22 according to the invention. The same characteristics bear the same reference signs as before. In this respect, please also refer to the previous description to avoid repetition. The chassis component 22 has a reinforcement part 23. The reinforcement part 23 essentially corresponds to the reinforcement part 12 according to FIG. 1 and is also completely embedded in the material of the articulated housing 2. The reinforcement part 23 also has the first leg 14, the second leg 15, and the ring section 16 connecting the two legs 14, 15 to one another.

In contrast to the reinforcement part 12 according to FIG. 1, the reinforcement part 23 shown here has a holding section 13 without holding tabs 17, 18. In this exemplary embodiment, the holding section 13 is thus not directly connected to the end section 5 of the connecting element 3. Instead, the holding section 13 shown here is connected to the end section 5 by means of a connecting section 24 of the articulated housing 2. The connecting section 24 is thus an integral part of the articulated housing 2 and is manufactured together with the articulated housing 2 during the injection molding of the latter.

### LIST OF REFERENCE NUMERALS

1 Chassis component
2 Articulated housing
3 Connecting elements
4 Longitudinal axis
5 End section
6 Recess
7 External engagement contour
8 External engagement contour
9 Internal engagement contours
10 Internal engagement contours
11 Articulated receptacle
12 Reinforcement part
13 Holding section
14 First leg
15 Second leg
16 Ring section
17 First holding tab
18 Second holding tab
19 Opening
20 First row
21 Second row
22 Chassis component
23 Reinforcement part
24 Connecting section

1. A chassis component comprising:
at least one articulated housing (2), wherein the articulated housing (2) has a blind hole-like recess (6);
a connecting element (3), wherein an end section (5) of the connecting element (3) engages in the recess (6), the end section (5) of the connecting element (3) has external engagement contours (7, 8), and the recess (6) has internal engagement contours (9, 10), wherein the external engagement contours (7, 8) and the internal engagement contours (9, 10) are configured to have corresponding shapes in order to realize a form-fit connection between the articulated housing (2) and the connecting element (3); and
a reinforcement part (12, 23) is arranged inside the articulated housing (2), wherein the reinforcement part (12, 23) has a holding section (13) connected to the end section (5) of the connecting element

2. The chassis component according to claim 1, wherein the reinforcement part (12, 23) is embedded in the material of the articulated housing (2).

3. The chassis component according to claim 1, wherein the articulated housing (2) has an articulated receptacle (11) configured as a recess to receive an articulated ball in an articulated manner, wherein the reinforcement part (12, 23) engages around and/or runs around the articulated receptacle (11).

4. The chassis component according to claim 3, comprising:
a first leg (14) of the reinforcement part (12, 23) extending from a first side of the end section (5) of the connecting element (3) in the direction of the articulated receptacle (11);
a second leg (15) of the reinforcement part (12, 23) extending from a second side of the end section (5) of the connecting element (3) in the direction of the articulated receptacle (11), wherein the first side and the second side of the end section (5) face away from each other; and
a ring section (16) of the reinforcement part (12, 23) connects the first leg (14) and the second leg (15) to each other, wherein the ring section (16) extends around the articulated receptacle (11).

5. The chassis component according to claim 1, wherein the reinforcement part (12, 23) defines at least one opening (19), wherein the at least one opening (19) is filled with the material of the articulated housing (2).

6. The chassis component according to claim 1, wherein the holding section (13) of the reinforcement part (23) is connected to the end section (5) of the connecting element (3) by means of a connecting part or by means of a connecting section (24) of the articulated housing (2), and wherein the articulated housing (2) is formed from a plastic material.

7. The chassis component according to claim 1, wherein the holding section (13) of the reinforcement part (12, 23) is connected by means of an adhesive connection and/or by means of a bonding agent, to the end section (5) of the connecting element (12, 23).

8. The chassis component according to claim 1, wherein the holding section (13) engages in a form-fitting manner in an engagement contour of the external engagement contours (7) of the end section (5) of the connecting element (3) such that the reinforcement part (12) is secured against being pulled off the connecting element (3) by virtue of the form-fit connection between the holding section (13) and the end section (5).

9. The chassis component according to claim 8, wherein the reinforcement part (12) has a first holding tab (17) and a second holding tab (18) forming the holding section (13), wherein the first holding tab (17) on a first side of the end section (5) engages in an engagement contour of the external engagement contours (7) of the end section (5) of the connecting element (3), and the second holding tab (18) engages on a second side, facing away from the first side, of the end section (5) in one or in the engagement contour of the external engagement contours (7) of the end section (5) of the connecting element (3).

10. The chassis component according to claim 1, wherein the connecting element (3) comprises a longitudinal axis (4) and the connecting element (3) extends out of the recess (6) in the direction of the longitudinal axis (4) and away from the recess (6), in particular the connecting element (3) is configured as a rod or as a tube, preferably the connecting element (3) is made of metal or plastic.

11. The chassis component of claim 2, wherein the articulated housing (2) is formed from a plastic material

12. The chassis component of claim 11, wherein the reinforcement part (12, 23) is formed from metal or a reinforced plastic
